(19) United States
(12) Patent Application Publication
(10) Pub. No.: US 2006/0150225 A1
(43) Pub. Date: Jul. 6, 2006

(54) Methods and systems for retaining and displaying pause buffer indicia across channel changes

(75) Inventors: Shannon C. Hegg, Mountain View, CA (US); Joerg Raymond Brown, Livermore, CA (US); Deepa Rajagopal, San Jose, CA (US); Judy L. Edighoffer, Pleasanton, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/029,874

(22) Filed: Jan. 5, 2005

(51) Int. Cl. H04N 7/173

(52) U.S. Cl. 725/89; 725/88; 725/102

(57) ABSTRACT

Methods and systems permit a pause buffer to retain its content across one or more channel changes. In addition, various embodiments provide the viewer with a robust browsing experiencing when navigating through content that resides in the pause buffer. For example, in at least some embodiments, the viewer can navigate through pause buffer content, via a status bar, and have displayed for them information associated with a program that corresponds to their current position in the pause buffer. Further, in at least some embodiments, a status bar can be displayed and can contain visually discernible indicia which provide information associated with the content in the pause buffer.

### TECHNICAL FIELD

This invention relates to entertainment systems and related information architectures and methods.

### BACKGROUND

Digital video recorders (DVRs) and personal video recorders (PVRs) are typically implemented as client devices to receive video content in the form of broadcast and/or interactive television entertainment and information, and on-demand entertainment, such as movies. A digital video recorder includes a hard disk memory so that a viewer can record the video content and other content of interest to the viewer. A digital video recorder also typically provides a viewer with convenient functionality, such as the ability to temporarily record broadcast content and, in turn, pause the broadcast of a television program and return to watch the video or program, while still in progress, from the point at which it was paused.

To implement this functionality, a digital video recorder includes what is referred to as a pause buffer. A pause buffer is typically configured to temporarily record for a predefined period of time, portions of one program to which the viewer's entertainment system was tuned. A pause buffer is typically configured as a circular, or ring buffer on the hard disk or random access (RAM) memory. The amount of time which a television program can be recorded into the pause buffer is dependent upon how much storage space is allocated for the pause buffer. When a pause buffer reaches capacity, such as after thirty minutes for example, the content corresponding to the beginning of pause buffer will be written over. This is referred to as “front truncating”. Thus, the pause buffer provides what can be thought of as a sliding recorder of the most recently displayed content.

When a viewer makes a channel selection, the broadcast content is received with the client device, such as a digital video recorder, and typically routed through the pause buffer to temporarily store a portion of the content, as well as displayed on a television or other suitable display.

The typical pause buffer is designed to temporarily record content from just one channel. That is, when a viewer executes a channel change, the previous content in the pause buffer is typically truncated or deleted, and the pause buffer starts out fresh on the new channel. Accordingly, the content from the previous channel is lost.

### SUMMARY

Methods and systems permit a pause buffer to retain its content across one or more channel changes. This provides a viewer with the freedom to change the channel without losing the content they have previously been watching.

In addition, various embodiments provide the viewer with a robust browsing experiencing when navigating through content that resides in the pause buffer. For example, in at least some embodiments, the viewer can navigate through pause buffer content, via a status bar, and have displayed for them information associated with a program that corresponds to their current position in the pause buffer. Further, in at least some embodiments, a status bar can be displayed and can contain visually discernible indicia which provide information associated with the content in the pause buffer. Such information can include, without limitation, a program's length, the amount of time a viewer was tuned to a particular program, the current position within a particular program, program information, channel, call sign, program name and various combinations of the above, as will become apparent below.

### BRIEF DESCRIPTION OF THE DRAWINGS

FIG. 1 is a block diagram that illustrates an exemplary entertainment system comprising an architecture in which the various inventive techniques can be implemented in accordance with one embodiment.

FIG. 2 illustrates an exemplary implementation of a client device that can be utilized to implement the various inventive techniques in accordance with one embodiment.

FIG. 3 illustrates an exemplary digital video recording system and related components in accordance with one embodiment.

FIG. 4 illustrates an exemplary digital video recording system which includes an exemplary digital video recorder that is configured to preserve pause buffer content across channel changes, and present a status bar to facilitate a viewer's navigation within the pause buffer, in accordance with one embodiment

FIG. 5 illustrates an exemplary status bar in accordance with one embodiment.

FIG. 6 illustrates an exemplary status bar in accordance with one embodiment.

FIG. 7 illustrates an exemplary status bar in accordance with one embodiment.

FIG. 8 illustrates an exemplary status bar in accordance with one embodiment.

FIG. 9 illustrates an exemplary status bar in accordance with one embodiment.

FIG. 10 illustrates an exemplary status bar in accordance with one embodiment.

FIG. 11 illustrates an exemplary status bar in accordance with one embodiment.

FIG. 12 illustrates an exemplary status bar in accordance with one embodiment.

FIG. 13 illustrates an exemplary status bar in accordance with one embodiment.

FIG. 14 illustrates an exemplary status bar in accordance with one embodiment.

FIG. 15 illustrates an exemplary display in accordance with one embodiment.

FIG. 16 illustrates an exemplary display in accordance with one embodiment.

FIG. 17 illustrates an exemplary status bar in accordance with one embodiment.

FIG. 18 illustrates an exemplary status bar in accordance with one embodiment.

FIG. 19 illustrates an exemplary status bar in accordance with one embodiment.

FIG. 20 illustrates an exemplary status bar in accordance with one embodiment.

FIG. 21 illustrates an exemplary status bar in accordance with one embodiment.

FIG. 22 illustrates an exemplary status bar in accordance with one embodiment.

FIG. 23 illustrates an exemplary status bar in accordance with one embodiment.

FIG. 24 illustrates an exemplary status bar in accordance with one embodiment.

FIG. 25 illustrates an exemplary status bar in accordance with one embodiment.

FIG. 26 is a flow diagram that describes steps in a method in accordance with one embodiment.

FIG. 27 is a flow diagram that describes steps in a method in accordance with one embodiment.

### DETAILED DESCRIPTION

Overview

The methods and systems described below permit a pause buffer to retain its content across one or more channel changes. This provides a viewer with the freedom to change the channel without losing the content they have previously been watching.

In addition, various embodiments provide the viewer with a robust browsing experiencing when navigating through content that resides in the pause buffer. For example, in at least some embodiments, the viewer can navigate through pause buffer content, via a status bar, and have displayed for them information associated with a program that corresponds to their current position in the pause buffer. Further, in at least some embodiments, a status bar can be displayed and can contain visually discernible indicia which provide information associated with the content in the pause buffer. Such information can include, without limitation, a program's length, the amount of time a viewer was tuned to a particular program, the current position within a particular program, program information, channel, call sign, program name and various combinations of the above, as will become apparent below.

Before describing the various inventive embodiments, the following discussion is provided to assist the reader in appreciating but one exemplary environment in which the various embodiments can be employed. Accordingly, the following discussion is directed to television-based entertainment and information systems, such as interactive TV networks, cable networks that utilize electronic program guides, and/or Web-enabled TV networks. Client devices in such systems typically include full-resource clients with substantial memory and processing resources, such as TV-enabled personal computers and digital video recorders equipped with hard-disks. While aspects of the described systems and methods can be used in any of these systems, as well as others, and for any types of client devices, the systems and methods below are described in the context of the following exemplary environment.

Exemplary System Architecture

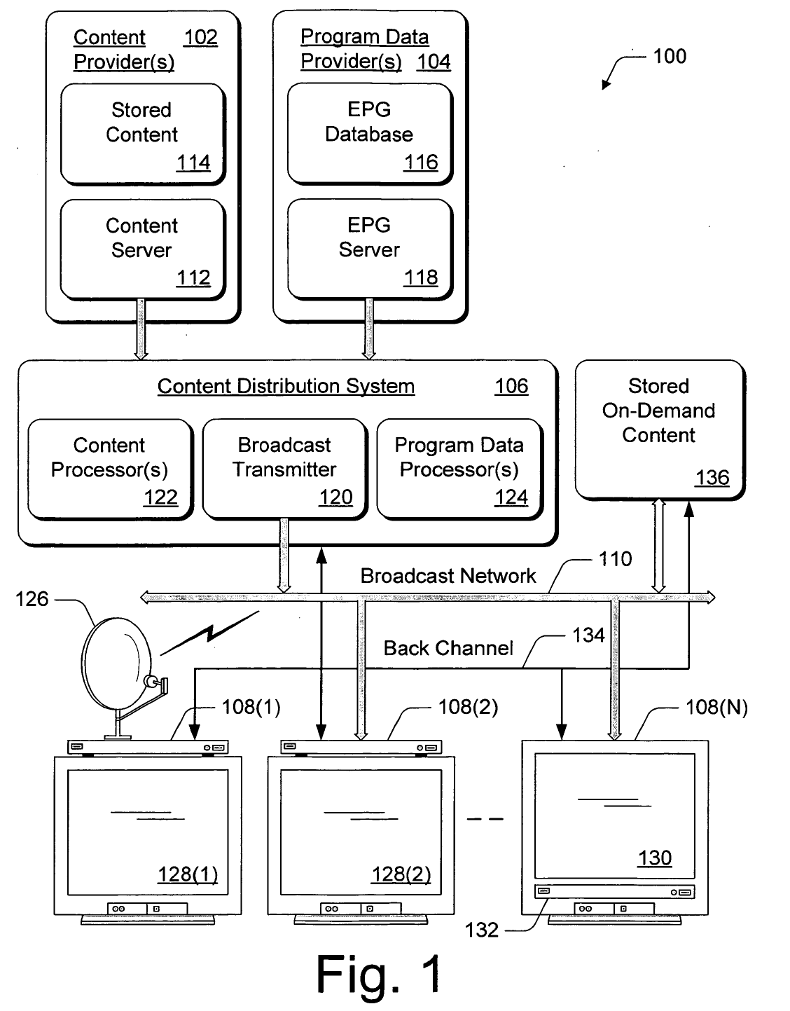

FIG. 1 illustrates an exemplary television entertainment system 100 comprising an architecture in which the various techniques described below can be implemented. System 100 facilitates distribution of content and program data to multiple viewers, and includes one or more content providers 102, one or more program data providers 104, a content distribution system 106, and multiple client devices 108(1), 108(2), . . . , 108(N) coupled to the content distribution system 106 via a broadcast network 110.

Content provider 102 includes a content server 112 and stored content 114, such as television programs, movies, commercials, music, and similar audio and/or video content. Content server 112 controls distribution of the stored content 114 from content provider 102 to the content distribution system 106. Additionally, content server 112 controls distribution of live content (e.g., content that was not previously stored, such as live feeds) and/or content stored at other locations to the content distribution system 106. Program data provider 104 includes an electronic program guide (EPG) database 116 and an EPG server 118. The EPG database 116 stores electronic files of program data which is used to generate an electronic program guide (or, “program guide”). Program data (or, “EPG data”) includes program titles, ratings, characters, descriptions, actor names, station identifiers, channel identifiers, schedule information, and so on.

The EPG server 118 processes the program data prior to distribution to generate a published version of the program data which contains programming information for all channels for one or more days. The processing may involve any number of techniques to reduce, modify, or enhance the program data. Such processes might include selection of content, content compression, format modification, and the like. The EPG server 118 controls distribution of the published version of the program data from program data provider 104 to the content distribution system 106 using, for example, a file transfer protocol (FTP) over a TCP/IP network (e.g., Internet or an Intranet). Further, the published version of the program data can be transmitted from program data provider 104 via a satellite directly to a client device 108.

Content distribution system 106 includes a broadcast transmitter 120, one or more content processors 122, and one or more program data processors 124. Broadcast transmitter 120 broadcasts signals, such as cable television signals, across broadcast network 110. Broadcast network 110 can include a cable television network, RF, microwave, satellite, and/or data network, such as the Internet, and may also include wired or wireless media using any broadcast format or broadcast protocol. Additionally, broadcast network 110 can be any type of network, using any type of network topology and any network communication protocol, and can be represented or otherwise implemented as a combination of two or more networks.

A content processor 122 processes the content received from content provider 102 prior to transmitting the content across broadcast network 110. Similarly, a program data processor 124 processes the program data received from program data provider 104 prior to transmitting the program data across broadcast network 110. A particular content processor 122 may encode, or otherwise process, the received content into a format that is understood by the multiple client devices 108(1), 108(2), . . . , 108(N) coupled to broadcast network 110. Although FIG. 1 shows a single content provider 102, a single program data provider 104, and a single content distribution system 106, exemplary system 100 can include any number of content providers and/or program data providers coupled to any number of content distribution systems.

Content distribution system 106 is representative of a headend service, or network operator, that provides EPG data, as well as content, to multiple subscribers. Each content distribution system 106 may receive a slightly different version of the program data that takes into account different programming preferences and lineups. The EPG server 118 creates different versions of EPG data (e.g., different versions of a program guide) that include those channels of relevance to respective headend services, and the content distribution system 106 transmits the EPG data to the multiple client devices 108(1), 108(2), . . . , 108(N). In one implementation, for example, content distribution system 106 utilizes a carousel file system to repeatedly broadcast the EPG data over an out-of-band (OOB) channel to the client devices 108.

Client devices 108 can be implemented in a number of ways. For example, a client device 108(1) receives broadcast content from a satellite-based transmitter via a satellite dish 126. Client device 108(1) is also referred to as a set-top box or a satellite receiving device. Client device 108(1) is coupled to a television 128(1) for presenting the content received by the client device (e.g., audio data and video data), as well as a graphical user interface. A particular client device 108 can be coupled to any number of televisions 128 and/or similar devices that can be implemented to display or otherwise render content. Similarly, any number of client devices 108 can be coupled to a single television 128.

Client device 108(2) is also coupled to receive broadcast content from broadcast network 110 and provide the received content to associated television 128(2). Client device 108(N) is an example of a combination television 130 and integrated set-top box 132. In this example, the various components and functionality of the set-top box are integrated into the television, rather than using two separate devices. The set-top box integrated into the television can receive broadcast signals via a satellite dish (similar to satellite dish 126) and/or via broadcast network 110. In alternate implementations, client devices 108 may receive broadcast signals via the Internet or any other broadcast medium, such as back channel 134 which can be implemented as an Internet protocol (IP) connection using a modem connection and conventional telephone line, for example. Further, back channel 134 provides an alternate communication link between each of the client devices 108, and between the client devices 108 and the content distribution system 106.

Each client device 108 can run an electronic program guide (EPG) application that utilizes the program data. An EPG application enables a television viewer to navigate through an onscreen program guide and locate television shows and other broadcast content of interest to the viewer. With an EPG application, the television viewer can look at schedules of current and future programming, set reminders for upcoming programs, and/or enter instructions to record one or more television shows.

The exemplary system 100 can also include stored on-demand content 136, such as video on-demand (VOD) movie content. The stored on-demand content 136 can be viewed with a television 128 via a client device 108 through an onscreen movie guide, for example, and a viewer can enter instructions to stream a particular movie, or other stored content, down to a corresponding client device 108.

Exemplary Client Device

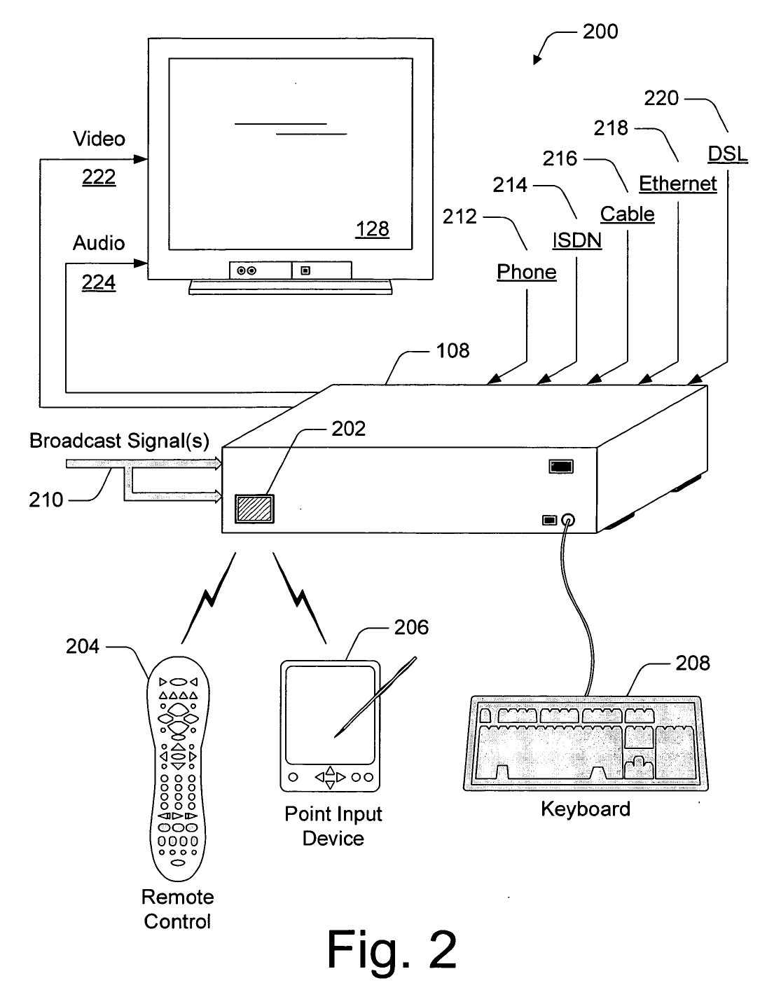

FIG. 2 illustrates an exemplary implementation 200 of a client device 108 shown as a standalone unit that connects to a television 128. Client device 108 can be implemented in any number of embodiments, including as a set-top box, a satellite receiver, a TV recorder with a hard disk, a digital video recorder (DVR) and playback system, a game console, an information appliance, and so forth.

Client device 108 includes, in this example, a wireless port 202, such as an infrared (IR) or Bluetooth wireless port, for receiving wireless communications from a remote control device 204, a handheld input device 206, or any other wireless device, such as a wireless keyboard. Handheld input device 206 can be a personal digital assistant (PDA), handheld computer, wireless phone, or the like. Additionally, a wired keyboard 208 can be coupled to communicate with client device 108. In alternate embodiments, remote control device 204, handheld device 206, and/or keyboard 208 may use an RF communication link or other mode of transmission to communicate with client device 108.

Client device 108 receives one or more broadcast signals 210 from one or more broadcast sources, such as from a satellite or from a broadcast network, such as broadcast network 110 (FIG. 1). Client device 108 includes hardware and/or software for receiving and decoding broadcast signal 210, such as an NTSC, PAL, SECAM, or other TV system video signal. Client device 108 also includes hardware and/or software for providing the user with a graphical user interface by which the user can, for example, access various network services, configure the client device 108, and perform other functions.

Client device 108 can communicate with other devices via one or more connections including a conventional telephone line 212, an ISDN link 214, a cable link 216, an Ethernet link 218, a DSL link 220, and the like. Client device 108 may use any one or more of the various communication links 212-220 at a particular instant to communicate with any number of other devices.

Client device 108 generates video signal(s) 222 and audio signal(s) 224, both of which are communicated to television 128. The video signals and audio signals can be communicated from client device 108 to television 128 via an RF (radio frequency) link, S-video link, composite video link, component video link, or other communication link. Although not shown in FIG. 2, client device 108 may include one or more lights or other indicators identifying the current status of the device. Additionally, the client device may include one or more control buttons, switches, or other selectable controls for controlling operation of the device.

Exemplary Digital Video Recording System

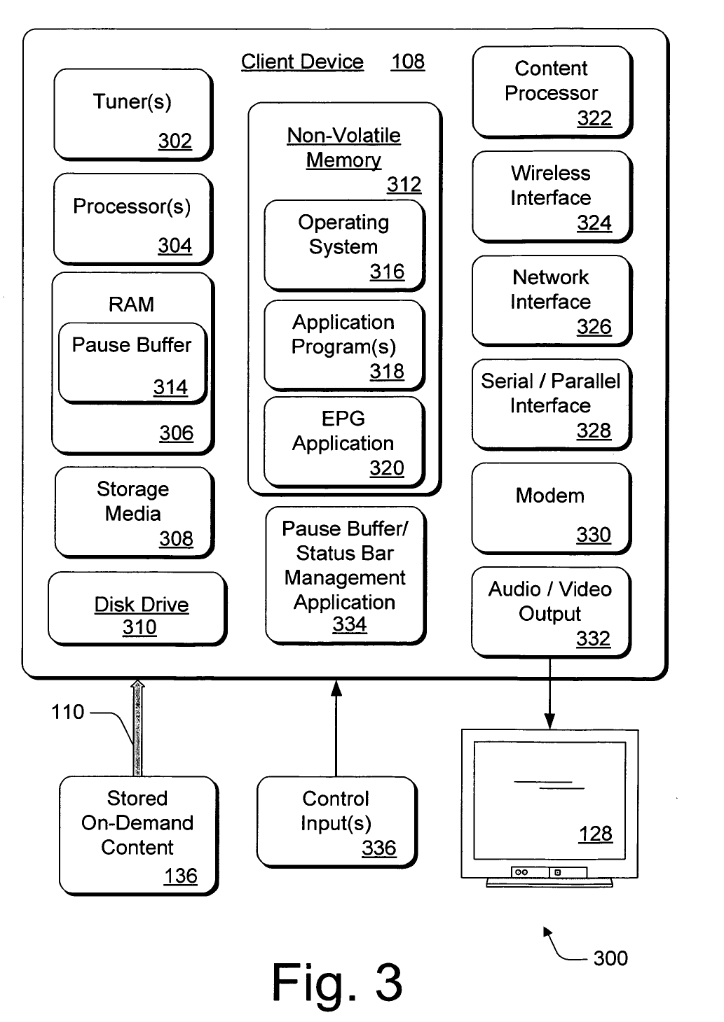

FIG. 3 illustrates an exemplary digital video recording system 300 that includes selected components of television system 100, such as an exemplary client device 108 as shown in FIGS. 1 and 2, and a television 128. Client device 108 includes components to implement a digital video recording system and techniques to preserve a pause buffer's content across one or more channel changes, as will become apparent below.

Client device 108 includes one or more tuners 302 which are representative of one or more in-band tuners that tune to various frequencies or channels to receive television signals, as well as an out-of-band tuner that tunes to the broadcast channel over which the EPG data is broadcast to client device 108. Client device 108 also includes one or more processors 304 which process various instructions to control the operation of client device 108 and to communicate with other electronic and computing devices.

Client device 108 can be implemented with one or more memory components, examples of which include a random access memory (RAM) 306, a mass storage media 308, a disk drive 310, and a non-volatile memory 312 (e.g., ROM, Flash, EPROM, EEPROM, etc.). The memory components (e.g., RAM 306, storage media 308, disk drive 310, and non-volatile memory 312) store various information and/or data such as received content, EPG data, configuration information for client device 108, and/or graphical user interface information.

Further, in at least one embodiment, RAM 306, as well as other computer-readable media such as the hard disk, can include a portion allocated as a short-term content buffer or pause buffer 314 which maintains segments of stored content 136 received via broadcast network 110. The short-term content buffer or pause buffer 314 maintains the most recent segment(s) of a broadcast program or segments of a received on-demand video.

An operating system 316 and one or more application programs 318 can be stored in non-volatile memory 312 and executed on a processor 304 to provide a runtime environment. A runtime environment facilitates extensibility of client device 108 by allowing various interfaces to be defined that, in turn, allow application programs 318 to interact with client device 108. The application programs 318 that may be implemented in client device 108 can include, without limitation, a browser to browse the Web (e.g., “World Wide Web”), an email program to facilitate electronic mail, a video recorder application or component to facilitate storing received content on disk drive 310 for example, and so on. An EPG application 320 is stored in memory 312 to operate on the EPG data and generate a program guide. Client device 108 can also include other components pertaining to a television entertainment system which are not illustrated in this example. For instance, client device 108 can include a user interface application and user interface lights, buttons, controls, and the like to facilitate viewer interaction with the device.

Client device 108 also includes a content processor and/or decoder 322 to process and decode a broadcast video signal, such as an NTSC, PAL, SECAM, or other TV system video signal. Content processor 322 can also include a video decoder and/or additional processors to receive, decode, and/or process video content received from content distribution system 106 (e.g., a network operator). For example, content processor 322 may include an MP3 or MPEG-2 (Moving Pictures Experts Group) decoder that decodes MPEG-encoded video and advertisement content. MPEG-2 supports a variety of audio/video formats, including legacy TV, HDTV (high-definition television), DVD (digital versatile disc), and five-channel surround sound.

Typically, video content includes video data and audio data that corresponds to the video data. Content processor 322 generates video and/or display content that is formatted for display on display device 128, and generates decoded audio data that is formatted for broadcast by a broadcast device, such as one or more speakers (not shown) in display device 128. Content processor 322 can include a display controller (not shown) that processes the video and/or display content to display corresponding images on display device 128. A display controller can include a microcontroller, integrated circuit, and/or similar video processing component to process the images. It is to be appreciated that the systems and methods described herein can be implemented for any type of encoding format as well as for data and/or content streams that are not encoded.

Client device 108 further includes a wireless interface 324, a network interface 326, a serial and/or parallel interface 328, and a modem 330. Wireless interface 324 allows client device 108 to receive input commands and other information from a user-operated input device, such as from a remote control device or from another IR, Bluetooth, or similar RF input device.

Network interface 326 and serial and/or parallel interface 328 allows client device 108 to interact and communicate with other electronic and computing devices via various communication links. Although not shown, client device 108 may also include other types of data communication interfaces to communicate with other devices. Modem 330 facilitates client device 108 communication with other electronic and computing devices via a conventional telephone line. Client device 108 also includes an audio and/or video output 332 that provides signals to television 128 or to other devices that process and/or display, or otherwise render, the audio and video data.

Client device 108 includes a pause buffer/status bar management application 334 that manages and preserves pause buffer content across channel changes, and presents a status bar to facilitate a viewer's navigation within the pause buffer, as will become apparent below. The pause buffer/status bar management application 334 can be implemented as a software component that executes on a processor 304 and is stored in non-volatile memory 312. The pause buffer/status bar management application 334 can also receive viewer commands as control inputs 336, such as from viewer-operated remote control device 204, handheld device 206, and/or keyboard 208. The viewer-inputs can include video display commands such as record, fast-forward, rewind, pause, and the like. The input commands may be input via an RF, IR, Bluetooth, or similar communication link or other mode of transmission to communicate with pause buffer/status bar management application 334.

Although shown separately, some of the components of client device 108 may be implemented in an application specific integrated circuit (ASIC). Additionally, a system bus (not shown) typically connects the various components within client device 108. A system bus can be implemented as one or more of any of several types of bus structures, including a memory bus or memory controller, a peripheral bus, an accelerated graphics port, or a local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

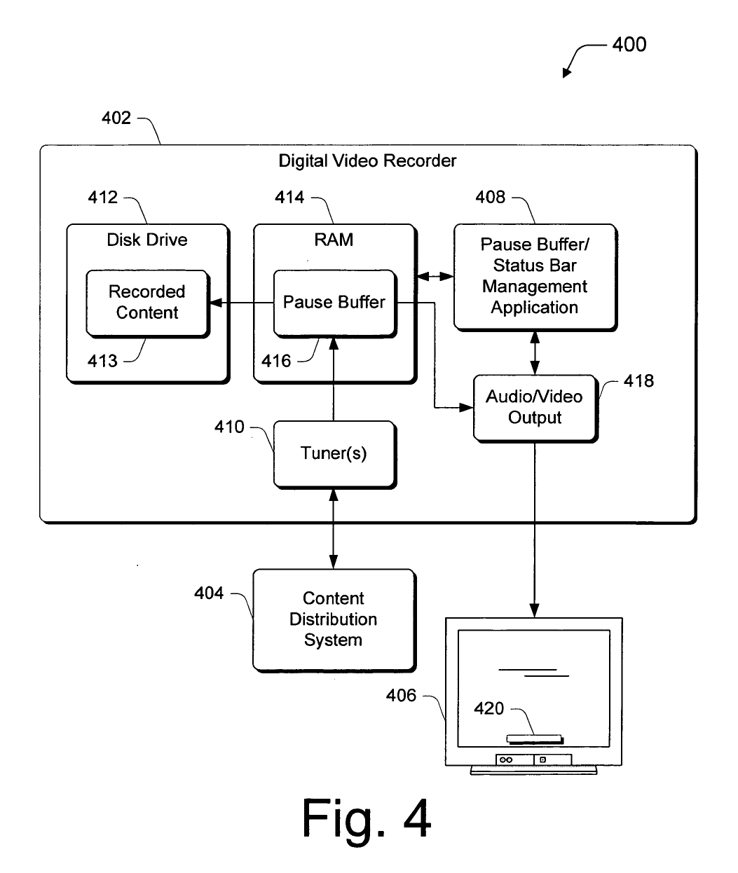

FIG. 4 illustrates a digital video recording system 400 which includes an exemplary digital video recorder 402 that is configured to preserve pause buffer content across channel changes, and present a status bar to facilitate a viewer's navigation within the pause buffer, in accordance with one embodiment. In this example, system 400 interacts with a content distribution system 404 to receive content as described above so that the content can be displayed on a display device 406, such as a television.

The illustrated and described digital video recorder 402 includes various components described with reference to exemplary client device 108 shown in FIG. 3, and can include any number and combination of the components to implement digital video recorder 402. In this particular example, digital video recorder 402 includes pause buffer/status bar management application 408, one or more tuner 410, a disk drive 412 for holding recorded content 413, memory 414 in the form of RAM embodying a short term content buffer or pause buffer 416, and an audio and/or video output component 418.

In this embodiment, when a viewer makes a channel selection to view a particular program, content distribution system 404 provides a content stream to digital video recorder 402 via broadcast network 110 which is received with tuner 410. The content stream is routed to the pause buffer 416 which maintains, under the influence of application 408, segments of the content stream, such as the most recent thirty minutes of content, for example. When the viewer executes a channel change, tuner 410 receives content associated with the new channel and routes the associated content stream to the pause buffer 416. The content associated with the new channel is placed into the pause buffer logically adjacent to the content from the previous channel. Accordingly, the pause buffer, under the influence of application 408, maintains the pause buffer's content across channel changes.

As the content stream is received and routed to the pause buffer, it is also routed to the audio and/or video output component 418 which communicates the content to television 406 where the content is displayed for viewing. Additionally, the content stream can be routed from the pause buffer 416 to generate a recording 413 of the movie which can be played back for later viewing.

Maintaining the content of the pause buffer across channel changes can be implemented in any suitable way and, in at least some instances, depends on or is driven by the structure and functionality of the file system that is employed. For example, in at least one embodiment, the content that resides in the pause buffer is typically maintained as a number of individual recordings or files. These recordings or files are accounted for using a master data structure that is managed by application 408. The master data structure can designate which files are associated with the pause buffer, and which files are associated with content that comprises part of recorded content 413. As a viewer changes channels and new files are added to the pause buffer, the master data structure is updated to account for the new files. At the same time, the master data structure maintains files associated with content from the previous channel or channels for a period of time associated with the length of the pause buffer.

In addition to managing the master data structure in a manner which maintains the pause buffer's content across channel changes, application 408 is configured, in at least some embodiments, to allow the viewer to navigate through content that resides in the pause buffer. Any suitable type of navigation instrumentality can be used, as will be appreciated by the skilled artisan. In but one embodiment, a navigation instrumentality in the form of a status bar 420 is provided to facilitate a viewer's navigation of the pause buffer's content. In these embodiments, examples of which are provided below, the status bar 420 can contain visually discernible indicia which provide information associated with the content in the pause buffer in a manner that allows the viewer to navigate the pause buffer's content. Another type of navigation instrumentality that can be utilized is a pie-type display in which, as a user navigates the pause buffer, a movable tick mark moves along the outside of the pie. Each “piece” of the pie would then represent how long the system was tuned to a particular channel.

Exemplary Status Bar and Associated Visually-Discernible Indicia

In the discussion that follows, various exemplary status bar embodiments are illustrated along with their associated visually-discernible indicia for promoting viewer navigation of the pause buffer's content. It is to be appreciated and understood that the examples that are provided just below are not to be used to limit application of the claimed subject matter to only those specific examples that are shown. Rather, visually discernible indicia other than that which is specifically illustrated can be utilized without departing from the spirit and scope of the claimed subject matter.

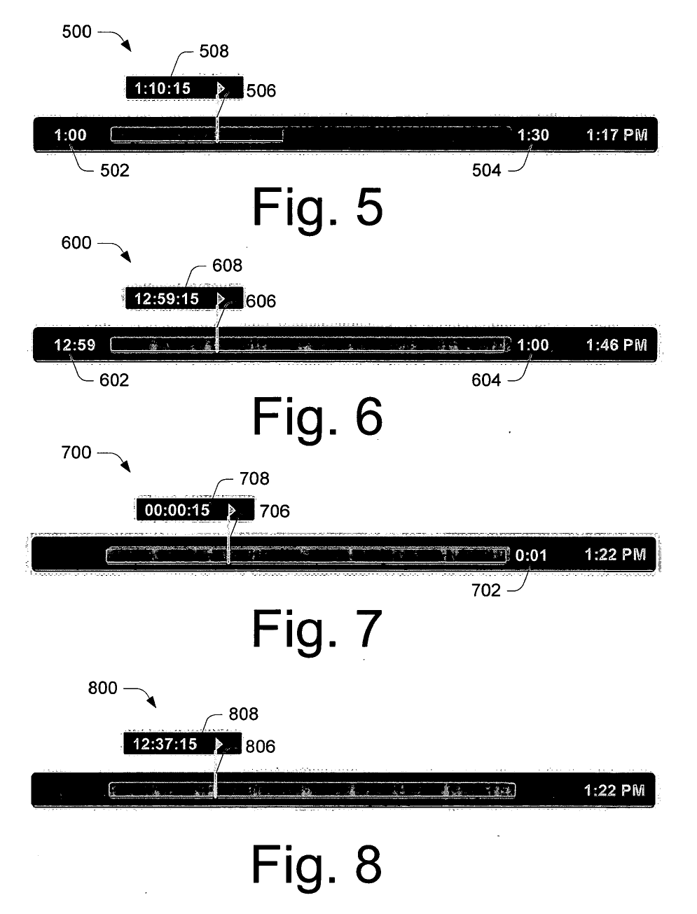

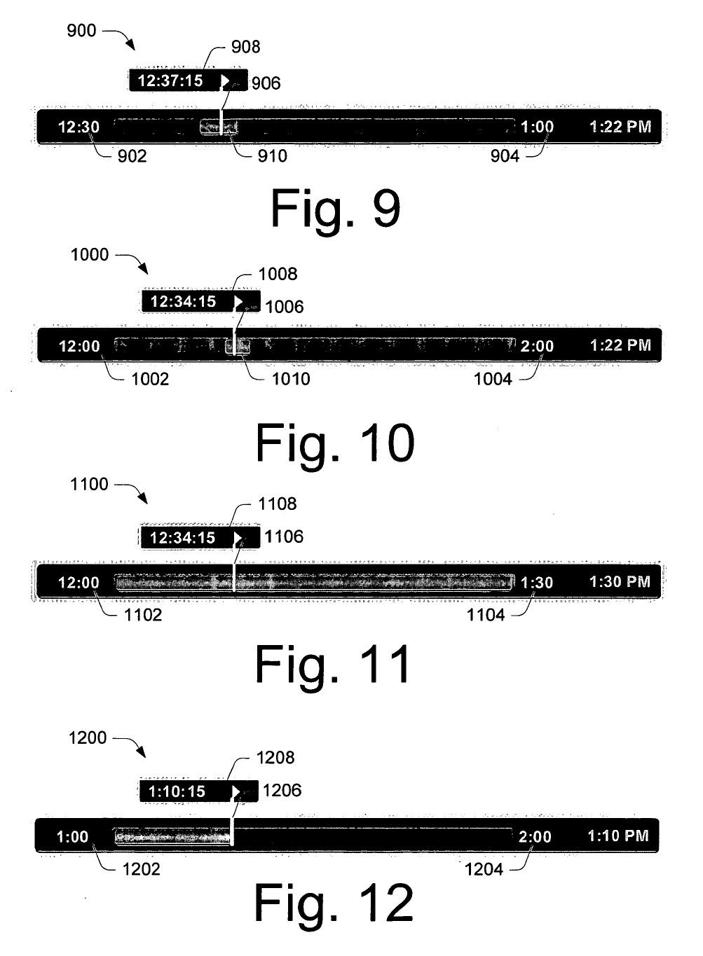

FIG. 5 shows an exemplary status bar 500 in accordance with one embodiment. In the examples set forth in FIGS. 6-10 below, FIG. 5 can be considered as the starting point for each of the navigation experiences of FIGS. 6-9, with FIG. 9 being the starting point for the FIG. 10 illustration. Accordingly, each of FIGS. 6-9 illustrates a separate embodiment whose starting point is the status bar of FIG. 5.

Here, the FIG. 5 status bar displays indicia associated with the program that the viewer is currently watching. In this particular example, the length of the current program is represented in the status bar by displaying the program's start time 502 and the program's end time 504. The start and end times are defined by the EPG data or, alternately, when the viewer set up a recording (e.g. via a manual record feature).

Status bar 500 also includes a current position indicator 506 that indicates the viewer's current position, as well as a time indicator 508 that indicates the viewer's time position within the current program. Hence, in this example, the viewer is watching a program that starts at 1:00 P.M. and ends at 1:30 P.M. Currently, the viewer is ten minutes and 15 seconds into the current program. Assume now that the viewer wishes to navigate the content contained in the pause buffer and rewinds into a previous program held in the pause buffer. Assume also that the previous program was broadcast on a different channel.

FIG. 6 shows an exemplary status bar 600 in accordance with one embodiment. Here, the status bar displays indicia associated with the previous program on the different channel. In this particular example, the length of the status bar represents the actual amount of time that the viewer spent on that particular channel. In addition, the status bar displays the start time 602 and the end time 604 of the program portion contained in the pause buffer, as well as a current position indicator 606 and time indicator 608. In this example, the viewer's system was only tuned to the corresponding program for one minute—from 12:59 P.M. to 1:00 P.M.—and the viewer is currently fifteen seconds into the buffered program portion.

FIG. 7 shows an exemplary status bar 700 in accordance with one embodiment. Here, the status bar displays indicia associated with the previous program on the different channel. In this particular example, the length of the status bar represents the actual amount of time that the viewer's tuner was tuned to that particular channel. In addition, the status bar displays only the time duration that the viewer's tuner was tuned to that channel. Accordingly, a time indicator 702 indicates that the viewer's system was tuned to that channel for one minute. A current position indicator 706 and time indicator 708 are also provided. In this example, the viewer's system was only tuned to the corresponding program for one minute (as indicated by time indicator 702), and the viewer is currently fifteen seconds into the buffered program portion.

FIG. 8 shows an exemplary status bar 800 in accordance with one embodiment. Here, the status bar displays indicia associated with the previous program on the different channel. In this particular example, the length of the status bar represents the actual amount of time that the viewer's tuner was tuned to that particular channel. In addition, this particular status bar embodiment does not display the time duration that the viewer's tuner was tuned to that channel. A current position indicator 806 and time indicator 808 provide, respectively, an indication of the viewer's current position and time within the buffered program portion.

In each of the embodiments of FIGS. 6-8, as the viewer navigates to different channels or shows contained in the pause buffer, the corresponding status bar refreshes for each new program or channel.

FIG. 9 shows an exemplary status bar 900 in accordance with one embodiment. Here, the status bar displays indicia associated with the previous program on the different channel. In this particular example, the length of the status bar represents the actual length of the previous program in accordance with the program's EPG data. In addition, the status bar displays the start time 902 and the end time 904 of the previous program, as well as a current position indicator 906 and time indicator 908. Further, in this embodiment, a visually discernible indication of the amount of time the viewer's tuner was tuned to the particular program is provided. In this particular example, the visually discernible indication comprises a color bar 910. Hence, in this example, the viewer's system was tuned to a program that was broadcast from 12:30 P.M. to 1:00 P.M. and the viewer's system was tuned to the corresponding program for a period of time that corresponds to color bar 910. In addition, the viewer is currently seven minutes and fifteen seconds into the previous program (only a portion of which is buffered in the pause buffer). Assume now that the viewer rewinds, from the status bar of FIG. 9, into an even earlier program.

FIG. 10 shows an exemplary status bar 1000 in accordance with the FIG. 9 embodiment. Here, the status bar displays indicia associated with the previous program. In this particular example, the length of the status bar again represents the actual length of the previous program in accordance with the program's EPG data. In addition, the status bar again displays the start time 1002 and the end time 1004 of the previous program, as well as a current position indicator 1006 and time indicator 1008. Further, in this embodiment as in the FIG. 9 embodiment, a visually discernible indication of the amount of time the viewer's tuner was tuned to the particular program is provided. In this particular example, the visually discernible indication again comprises a color bar 1010. Hence, in this example, the viewer's system was tuned to a program that was broadcast from 12:00 P.M. to 2:00 P.M. and the viewer's system was tuned to the corresponding program for a period of time that corresponds to color bar 1010. In addition, the viewer is currently 34 minutes and fifteen seconds into the previous program (only a portion of which is buffered in the pause buffer).

In the embodiments of FIGS. 9 and 10, as the viewer rewinds into previous programs, the associated current position indicator 906, 1006 and the color bar 910, 1010 move around on the status bar to indicate the viewer's actual position relative to the program portion that resides in the pause buffer.

FIG. 11 shows an exemplary status bar 1100 in accordance with one embodiment. In this particular example, the length of the status bar represents a predetermined amount of time corresponding to a predetermined amount of the pause buffer. In one embodiment, the predetermined amount of time corresponds to the entire length of the pause buffer. So, for example, if the pause buffer is configured to hold 90 minutes of content, the length of the status bar would represent 90 minutes of content. In this embodiment, all of the rewind and fast forward operations occur within a single displayed status bar. In addition, the status bar displays the start time 1102 and the end time 1104 of the pause buffer, as well as a current position indicator 1106 and time indicator 1108. In this example, the system's pause buffer holds 90 minutes of content and the viewer is currently 34 minutes and fifteen seconds into the buffered content.

FIGS. 12-14 illustrate a status bar 1200 in accordance with another embodiment. In this example, the length of the status bar corresponds to a pre-determined amount of time. Any suitable predetermined amount of time can be utilized. In the present example, however, the length of the status bar corresponds to an hour's worth of content. In addition, the status bar displays the start time 1202 and the end time 1204 of the time to which the status bar's length corresponds. In the illustrated example, the particular hour that is displayed is that which contains the current position indicator. In addition, a current position indicator 1206 and time indicator 1208 indicate, respectively, the viewer's current position and time position within the pause buffer. Hence, in this example, the current position is shown as 1:10:15 and, because of this, falls within the range of 1:00-1:59. As such, the length of the status bar is indicated as corresponding to the 1:00-2:00 hour. When the time reaches exactly 2:00:00 in this embodiment, the status bar is refreshed to show the start time of 2:00 and the end time of 3:00.

Assume now that the viewer rewinds through the status bar into the previous hour. In this case, as indicated in FIG. 13, the status bar refreshes to indicate a start time of 12:00 P.M. and an end time of 1:00 P.M. Assume further that the user rewinds through the status bar into the next previous hour. In this case, as indicated in FIG. 14, the status bar refreshes to indicate a start time of 11:00 A.M. and an end time of 12:00 P.M.

In addition, in the FIGS. 12 and 14, the end and beginning of the pause buffer can be seen to correspond, respectively, to the lighter colored regions which occupy roughly a third of each respective status bar.

In the embodiment of FIGS. 12-14, the status bar provides, by virtue of the lighter colored regions associated with the pause buffer, a visually discernible indication of the navigable extent of the pause buffer. For example, in the FIG. 12 status bar, the viewer can ascertain that they are approaching the end of the pause buffer. In the FIG. 13 status bar, the viewer can freely navigate within the pause buffer throughout the entire length of the status bar. In the FIG. 14 status bar, the viewer can ascertain that they are approaching the beginning of the pause buffer.

Displaying Program Information with Browsed Pause Buffer Content

In at least some embodiments, client device 108 is configured to coordinate displayable program information with pause buffer content that is browsed by the viewer. This can be done in response to actions that are taken by the viewer (e.g. pressing a “Program Information” button on an input device), automatically without requiring any viewer action, or both.

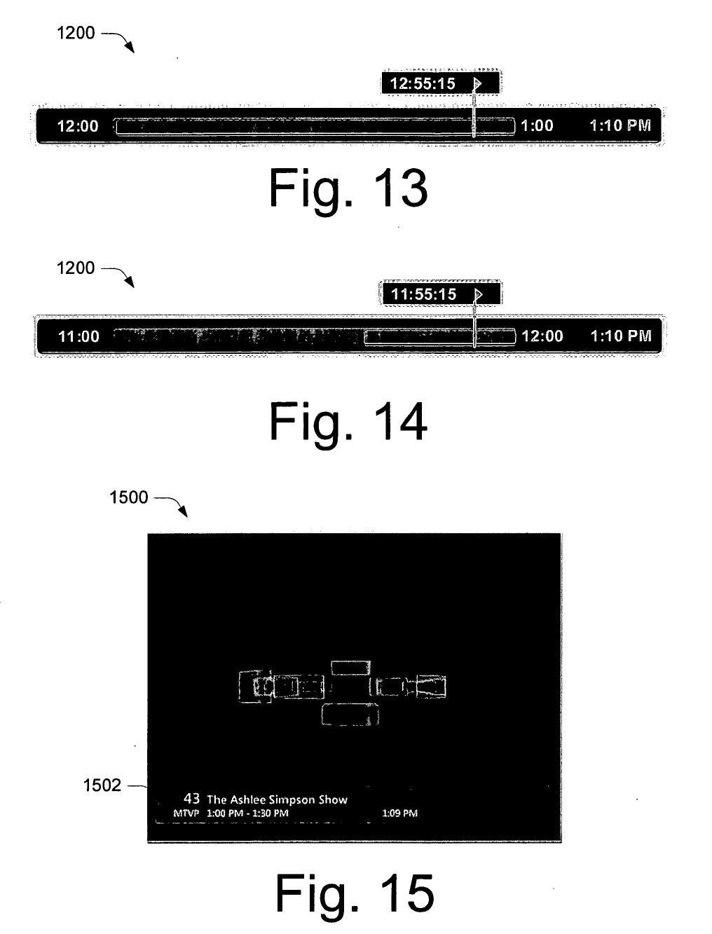

As but one example, consider FIG. 15 which shows a display 1500 that is presented to a viewer as they browse the pause buffer. Here, a channel or information bar 1502 is presented and corresponds to the program to which the viewer has browsed. In this particular example, the viewer has browsed the pause buffer to “The Ashlee Simpson Show”. The channel bar 1502 displays, in this example, the title of the program, the call sign of the station, the channel number, and the time period over which the program is broadcast.

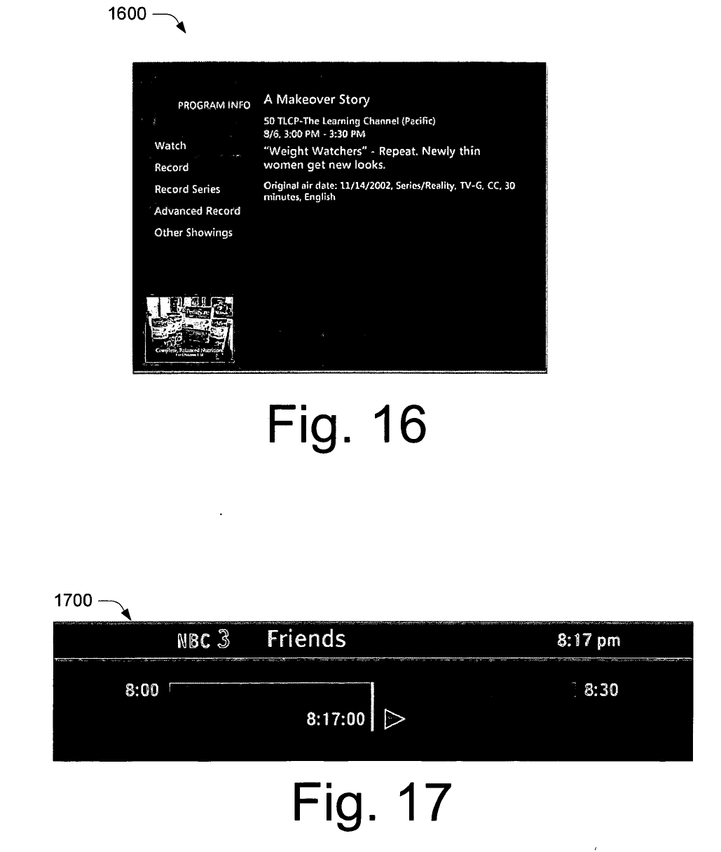

As another example, consider FIG. 16 which shows a display 1600 that is presented to a viewer responsive to the user pressing a “Program Information” button on their input device. Here, a viewer browses to a program in the pause buffer and, via the “Program Information” button, access additional information associated with the program.

In at least some embodiments, the displayable program information is presented in association with the status bar that is presented to the viewer. As an example, consider FIG. 17 which illustrates an exemplary status bar 1700 which can comprise any of the status bars discussed above. In addition to the status bar, program information in the form of a program title, station call sign and channel number are presented to the viewer. In this embodiment, presentation of the program information occurs automatically as the user browses the pause buffer.

Impulse Recording

In accordance with one embodiment, client device 108 is configured to allow viewers to record (i.e. as a permanent recording) any portion of the pause buffer. In this embodiment, as the viewer browses the pause buffer, they may come across a program that they wish to permanently record or preserve so that it is not front truncated when the pause buffer begins to clear earlier recorded programs. In this case, the user can provide an indication to the system that it is to permanently record the pause buffer material. In one embodiment, the user may provide this indication by pressing the “Program Information” button and selecting a “Record” menu item, such as the “Record” menu item shown in FIG. 16.

When this occurs, depending on the file system implemented by the client device, the corresponding pause buffer content is processed to indicate that it is now a permanent recording. This can involve, for example, tagging a particular file or files, or executing a copy operation to move the corresponding content to a more permanent location on the hard disk.

Status Bar Extensions

In addition to the embodiments described, various status bar extensions are provided that can be suitably incorporated into any of the status bar embodiments described above. Each of these extensions is discussed below under its own separate heading.

Color Coding Most Recent Program

FIG. 18 illustrates a status bar 1800 in accordance with one embodiment. In this embodiment, a region of the status bar that corresponds to the current program is color coded. In the illustrated example, color coded region 1802 corresponds to the current program. By color coding the current program, a more visually discernible reference is provided to the viewer to assist the viewer in making program-related decisions. For example, the user may currently be watching the program “Friends” and may be 25 minutes into the program. At this point, the viewer may decide that they wish to permanently record the episode. By glancing at the status bar's color coded region associated with the current program, the viewer ascertains that they can still make a recording decision with regards to the current program because some portion of the color coded region remains to the right of the current position indicator. Accordingly, the viewer can select the appropriate menu item and have the content of the pause buffer that corresponds to “Friends” permanently recorded.

Color Coding Channel Changes

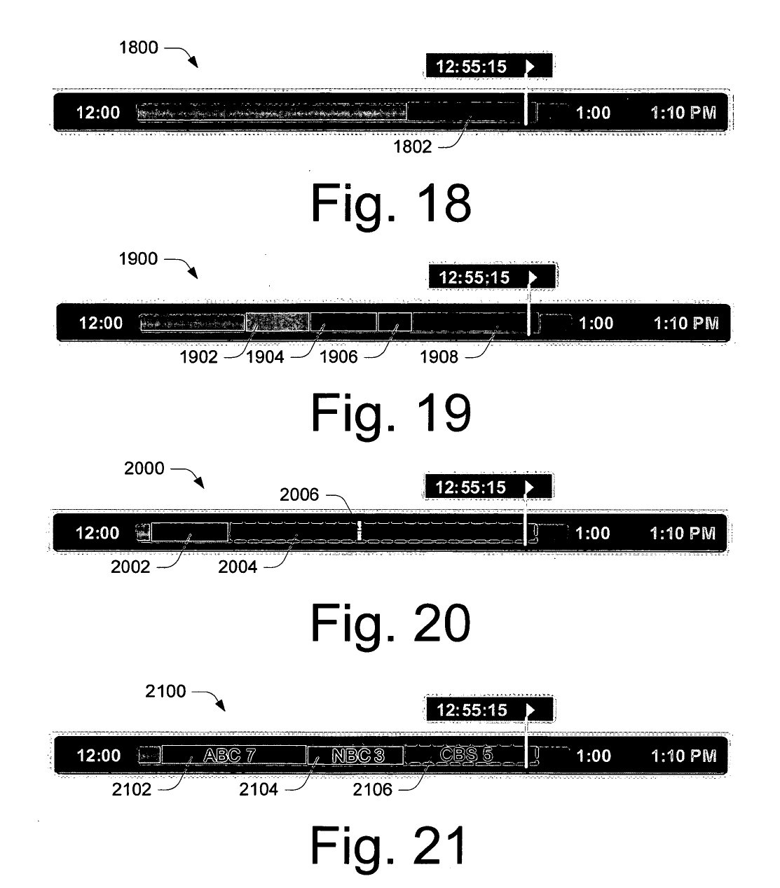

FIG. 19 illustrates a status bar 1900 in accordance with another embodiment. In this embodiment, various regions of the status bar are color coded with different colors or patterns to indicate channel changes in a visually discernible manner. In the illustrated example, four such regions are indicated at 1902, 1904, 1906 and 1908. Hence, in this example, the viewer changed the channel four times and the content associated with channels to which the system was tuned now resides in the pause buffer.

Color Coding Channel Changes and Highlighting Program Boundaries

FIG. 20 illustrates a status bar 2000 in accordance with another embodiment. In this embodiment, various regions of the status bar are color coded with different colors or patterns to indicate channel changes in a visually discernible manner. Two such regions are shown at 2002 and 2004. In addition, visual indicia is provided to indicate, within any one particular channel, program boundaries that define two different programs. In this example, the program boundary indicia comprises a broken line 2006 disposed within region 2004.

Color Coding Channel Changes and Providing Channel Information

FIG. 21 illustrates a status bar 2100 in accordance with another embodiment. In this embodiment, various regions of the status bar are color coded with different colors or patterns to indicate channel changes in a visually discernible manner. Three such regions are shown at 2102, 2104 and 2106. In addition, program information is associated with the colored regions. In this example, the program information comprises the station call sign and channel number, each of which is inserted into a corresponding colored region. Hence, in this example, the viewer first turned to ABC Channel 7, then to NBC Channel 3, and then to CBS Channel 5.

Program Information Bar and Status Bar

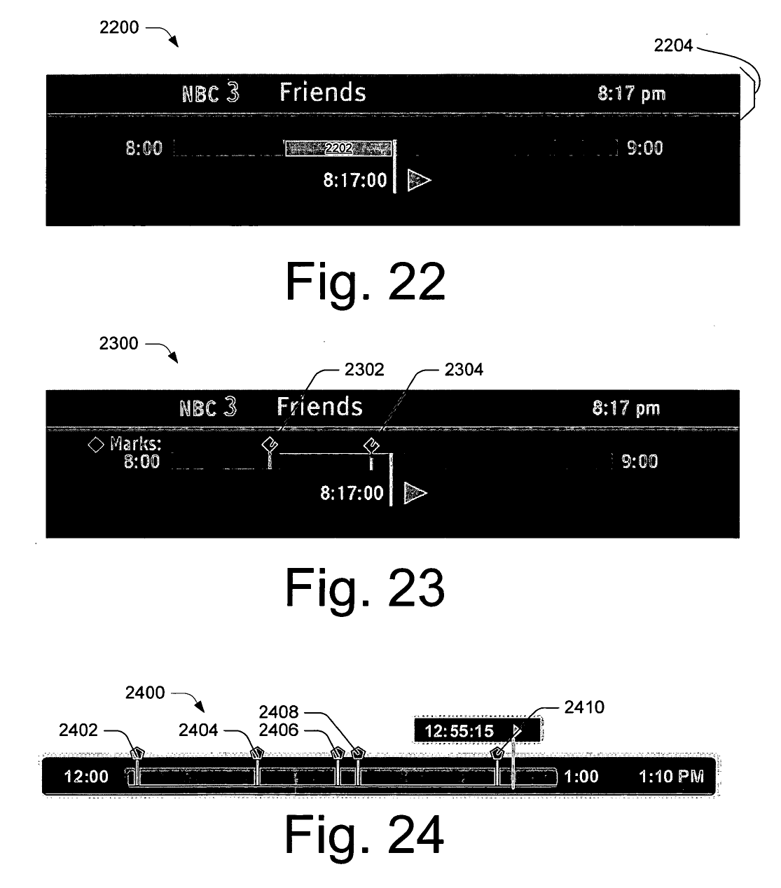

FIG. 22 illustrates a status bar 2200 in accordance with another embodiment. In this embodiment, various regions of the status bar are color coded with different colors or patterns to indicate channel changes in a visually discernible manner. In this example, one such region is shown at 2202. In addition, a program information bar 2204 is provided adjacent the status bar and provides information associated with the program to which the viewer's current status bar location corresponds. In this example, the viewer has navigated in the status bar to a location that corresponds to the program “Friends”, an indication of which appears in the program information bar 2204.

Setting Bookmarks on the Status Bar

In accordance with another embodiment, application 408 (FIG. 4) is configured to enable bookmarks to be applied to the status bar. In some embodiments, the viewer can set or apply the bookmarks. Alternately or additionally, in some embodiments, the bookmarks can be set or applied automatically.

Viewer-Applied Bookmarks

FIG. 23 illustrates a status bar 2300 in accordance with another embodiment. In this embodiment, a viewer can set bookmarks on the status bar regardless of channel changes. In the present example, two such bookmarks 2302, 2304 appear on the status bar. The bookmarks represent a point in a program to which a viewer thinks they may wish to return at a later time.

Automatically-Applied Bookmarks

FIG. 24 illustrates a status bar 2400 in accordance with another embodiment. Here, the system automatically sets bookmarks to delineate channel changes. In the present example, five such bookmarks are shown at 2402, 2404, 2406, 2408 and 2410. In accordance with this embodiment, these bookmarks may or may not necessarily be used to help viewers navigate to previous points in the pause buffer.

Directional Indicia to Facilitate Viewer Navigation

In accordance with one embodiment, directional indicia can be added to the status bar to provide the viewer with an understanding of the various directions that they can navigate on the status bar, and hence the pause buffer.

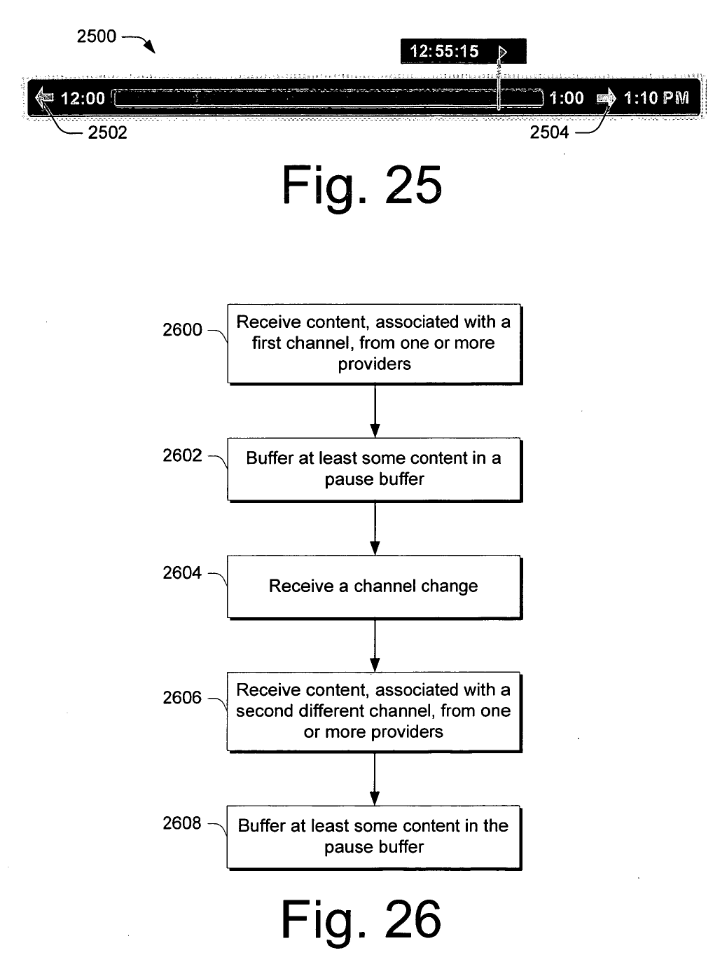

As such, FIG. 25 illustrates a status bar 2500 in accordance with an embodiment in which directional indicia in the form of arrows 2502 and 2504 is provided. In this particular example, the directional indicia indicate that the viewer is free to navigate backward along the status bar (and hence rewind from their current position) and forward along the status bar (and hence fast forward from their current position).

When the viewer approaches the beginning or end of the pause buffer, one of the corresponding directional indicia will disappear. For example, as the viewer approaches the beginning of the pause buffer, arrow 2502 will disappear to indicate that the viewer has reached (or will shortly reach) the beginning of the pause buffer. Correspondingly, as the viewer approaches the end of the pause buffer, arrow 2504 will disappear to indicate that the viewer has reached (or will shortly reach) the end of the pause buffer.

Exemplary Method

FIG. 26 illustrates a flow diagram that describes steps in a method for preserving a pause buffer's content across channel changes in accordance with one embodiment. The method can be implemented in connection with any suitable hardware, software, firmware or combination thereof. In but one embodiment, the method can be implemented in connection with systems such as those that are shown and described in FIGS. 1-4.

Step 2600 receives content, associated with a first channel, from one or more providers. Examples of such content and providers are given above. Step 2602 buffers at least some of the content in a pause buffer. Examples of how this can be done are given above. Step 2604 receives a channel change indication. The channel change indication can be received from a viewer, as by the viewer physically changing the channel. Alternately or additionally, the channel change indication can be automatically generated by the system, as by a previously-programmed record request. Step 2606 receives content, associated with a second different channel, from one or more providers. Step 2606 buffers at least some of the content associated with the different channel in the pause buffer. In the illustrated and described embodiments, steps 2602 and 2606 are performed in a manner that preserves the pause buffer's content across channel changes. Examples of how this can be done are provided above.

It is to be appreciated that the method can return to step 2604 and repeat the subsequent steps for as many channel changes as the viewer executes. Accordingly, the method can preserve content for multiple channel changes and preserves the content for each of the channel changes. In one embodiment, the only limitation on the amount of the preserved content stems from the volume of memory or storage allocated for the pause buffer.

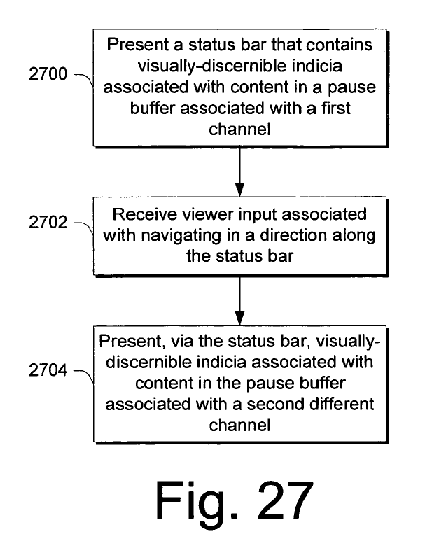

FIG. 27 illustrates a flow diagram that describes steps in a method for presenting a navigation instrumentality for allowing a viewer to navigate the through a pause buffer's content which has been preserved across channel changes in accordance with one embodiment. Although any suitable navigation instrumentality can be used, in the method described below a navigation instrumentality in the form of a status bar is utilized.

The method can be implemented in connection with any suitable hardware, software, firmware or combination thereof. In but one embodiment, the method can be implemented in connection with systems such as those that are shown and described in FIGS. 1-4.

Step 2700 presents a status bar that contains visually-discernible indicia associated with content in a pause buffer associated with a first channel. Various examples of status bars are provided above. Step 2702 receives viewer input associated with navigating in a direction along the status bar. The input can be received in any suitable manner. Various examples of input devices that can be used to provide such input are provided above.

Responsive to step 2702, step 2704 presents, via the status bar, visually-discernible indicia associated with content in the pause buffer associated with a second different channel.

Accordingly, this method enables a status bar to present visually-discernible indicia associated with content in a pause buffer in a manner that preserves the pause buffer's content across channel changes.

### CONCLUSION

The methods and systems described above permit a pause buffer to retain its content across one or more channel changes. This provides a viewer with the freedom to change the channel without losing the content they have previously been watching.

In addition, various embodiments provide the viewer with a robust browsing experiencing when navigating through content that resides in the pause buffer. For example, in at least some embodiments, the viewer can navigate through pause buffer content, via a status bar, and have displayed for them information associated with a program that corresponds to their current position in the pause buffer. Further, in at least some embodiments, a status bar can be displayed and can contain visually discernible indicia which provide information associated with the content in the pause buffer. Such information can include, without limitation, program length, the amount of time a viewer was tuned to a particular program, current position within a particular program, program information, channel, call sign, program name and various combinations of the above, as will become apparent below.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method comprising:
receiving content associated with a first channel;
buffering at least some of the received content in a pause buffer;
receiving a channel change;
receiving content associated with a different channel; and
buffering at least some of the content associated with the different channel in the pause buffer in a manner that preserves received content across one or more channel changes.

2. The method of claim 1, wherein the channel change comprises a channel change initiated by a viewer.

3. The method of claim 1, wherein the channel change comprises a channel change associated with a pre-programmed recording request.

4. The method of claim 1, wherein the acts of buffering are performed, at least in part, using a data structure that designates content files associated with the pause buffer, and content files not associated with the pause buffer.

5. The method of claim 1, wherein the acts of buffering are performed by placing content from the first and second channels into the pause buffer logically adjacent one another.

6. The method of claim 1 further comprising repeating, at least one time, the acts of:
receiving the channel change,
receiving content associated with the different channel, and
buffering at least some of the content associated with the different channel in the pause buffer.

7. The method of claim 1 further comprising presenting a navigation instrumentality to facilitate a viewer's navigation of the pause buffer's content.

8. One or more computer-readable having computer-readable instructions thereon which, when executed, implement the method of claim 1.

9. A client device embodying the one or more computer-readable media of claim 8.

10. A digital video recorder embodying the one or more computer-readable media of claim 8.

11. A method comprising:
receiving content associated with a first channel;
buffering at least some of the received content in a pause buffer;
receiving multiple channel changes;
receiving content associated with each of the multiple channel changes;
buffering at least some of the content associated with the multiple channels in the pause buffer in a manner that preserves received content across the multiple channel changes; and
presenting a navigation instrumentality to facilitate a viewer's navigation of the pause buffer's content.

12. The method of claim 11, wherein at least one channel change comprises a channel change initiated by a viewer.

13. The method of claim 11, wherein at least one channel change comprises a channel change associated with a pre-programmed recording request.

14. The method of claim 11, wherein the acts of buffering are performed, at least in part, using a data structure that designates content files associated with the pause buffer, and content files not associated with the pause buffer.

15. The method of claim 11, wherein the acts of buffering are performed by placing content from serially adjacent channel changes into the pause buffer logically adjacent one another.

16. One or more computer-readable media having computer-readable instructions thereon which, when executed, implement a method comprising:
receiving content associated with a first channel;
buffering at least some of the received content in a pause buffer;
receiving multiple channel changes;
receiving content associated with each of the multiple channel changes;
buffering at least some of the content associated with the multiple channels in the pause buffer in a manner that preserves received content across the multiple channel changes; and
presenting a navigation instrumentality to facilitate a viewer's navigation of the pause buffer's content.

17. The one or more computer-readable media of claim 16, wherein at least one channel change comprises a channel change initiated by a viewer.

18. The one or more computer-readable media of claim 16, wherein at least one channel change comprises a channel change associated with a pre-programmed recording request.

19. The one or more computer-readable media of claim 16, wherein the acts of buffering are performed, at least in part, using a data structure that designates content files associated with the pause buffer, and content files not associated with the pause buffer.

20. The one or more computer-readable media of claim 16, wherein the acts of buffering are performed by placing content from serially adjacent channel changes into the pause buffer logically adjacent one another.
